(19) United States
(12) Patent Application Publication
(10) Pub. No.: US 2014/0015819 A1
(43) Pub. Date: Jan. 16, 2014

(54) Method for Driving Display Device and Display Device

(71) Applicant: Semiconductor Energy Laboratory Co., Ltd., Kanagawa-ken (JP)

(72) Inventors: Shunpei Yamazaki, Tokyo (JP); Jun Koyama, Sagamihara (JP); Yoshiharu Hirakata, Ebina (JP); Hiroyuki Miyake, Atsugi (JP)

(73) Assignee: Semiconductor Energy Laboratory Co., Ltd., Kanagawa-ken (JP)

(21) Appl. No.: 13/939,853

(22) Filed: Jul. 11, 2013

(30) Foreign Application Priority Data
Jul. 13, 2012 (JP) 2012-157456

(51) Int. Cl. G09G 3/36

(52) U.S. Cl. CPC G09G 3/3614
USPC 345/209

(57) ABSTRACT

Power consumption is sufficiently reduced even when a moving image is displayed at an increased driving frequency. A liquid crystal display device includes a signal generation circuit which outputs a polarity inversion signal that is generated in accordance with a count value obtained by counting cycles of a vertical synchronization signal and a source driver which switches a polarity of video signals input to a pixel in accordance with the polarity inversion signal. The polarity of the video signals is kept the same for m (m is greater than or equal to 2) or more frame periods by the polarity inversion signal.

### BACKGROUND OF THE INVENTION

1. Field of the Invention

The present invention relates to a method for driving a display device and to a display device.

2. Description of the Related Art

In recent years, attention has been focused on the development of low-power consumption display devices.

To reduce power consumption of display devices, reducing the number of times of rewriting a video signal is important. For example, to reduce the number of times of rewriting a video signal, techniques in which a break period longer than a scanning period is provided as a non-scanning period every time after a video signal is written by scanning a screen in the case of displaying a still image have been reported (e.g., see Patent Document 1 and Non-Patent Document 1).

### REFERENCE

### Patent Document

[Patent Document 1] U.S. Pat. No. 7,321,353

### Non-Patent Document

[Non-Patent Document 1] K. Tsuda et al., IDW'02, Proc., pp. 295-298

### SUMMARY OF THE INVENTION

In the driving method described in Patent Document 1, power consumption can be reduced only in the case of displaying a still image in the entire screen. A technique for reducing power consumption is demanded in the case of displaying a moving image, where screen data needs to be written by scanning the entire screen.

There is a recent trend in display devices toward more pixels and higher driving frequencies of 60 Hz, 120 Hz, and 240 Hz to display a higher definition, higher resolution, and less flickering image; accordingly, gate line driver circuits and source line driver circuits are required to operate at higher speed. Thus, demands for a technique for reducing power consumption arise also in view of increased power consumption attributed to higher driving frequencies.

The mainstream of a display device structure is a structure in which inversion driving is performed at least every frame period to reduce influence of burn-in due to deterioration of a display element, such as gate line inversion driving, source line inversion driving, frame inversion driving, or dot inversion driving.

However, a problem in inversion driving in which the polarity of a video signal written into a pixel is changed every frame period is that, even if the voltage applied to a display element is almost unchanged, the amount of change in video signal potential increases and accordingly power consumption increases. This problem is particularly prominent in driving with a high frequency, in which case a technique for further reducing power consumption is demanded.

In view of the above, an object of one embodiment of the present invention is to provide a display device in which power consumption can be sufficiently reduced even when a moving image is displayed at an increased driving frequency, and a method for driving the display device.

One embodiment of the present invention is a liquid crystal display device including a signal generation circuit which outputs a polarity inversion signal that is generated in accordance with a count value obtained by counting cycles of a vertical synchronization signal and a source driver which switches a polarity of video signals to be input to a pixel in accordance with the polarity inversion signal. The polarity of the video signals is kept the same for m (m is greater than or equal to 2) or more frame periods by the polarity inversion signal.

Another embodiment of the present invention is a liquid crystal display device including a signal generation circuit which outputs a polarity inversion signal that is generated in accordance with a count value obtained by counting cycles of a vertical synchronization signal and a source driver which switches a polarity of video signals to be input to a pixel in accordance with the polarity inversion signal. The cycles of the vertical synchronization signal are counted up to m (m is greater than or equal to 2) or more cycles so that the polarity of the video signals is kept the same for m or more frame periods by the polarity inversion signal.

In the liquid crystal display device of one embodiment of the present invention, the video signals supplied in accordance with the polarity inversion signal in one frame period preferably have the same polarity in all the pixels.

In the liquid crystal display device of one embodiment of the present invention, the video signals supplied in accordance with the polarity inversion signal in one frame period preferably have either a positive polarity or a negative polarity in pixels connected to the same source line.

In the liquid crystal display device of one embodiment of the present invention, the video signals supplied in accordance with the polarity inversion signal in one frame period preferably have a positive polarity in a first region of pixels arranged in a matrix and a negative polarity in a second region of the pixels.

In the liquid crystal display device of one embodiment of the present invention, a blank period in which a potential of a video signal is set to a common potential is preferably provided every m frame periods before the polarity of the video signals is switched.

Another embodiment of the present invention is a method for driving a liquid crystal display device. The liquid crystal display device includes a signal generation circuit which outputs a polarity inversion signal that is generated in accordance with a count value obtained by counting cycles of a vertical synchronization signal. In the method, the polarity inversion signal is switched between an H level and an L level every m (m is greater than or equal to 2) frame periods and a video signal whose polarity is switched in accordance with the polarity inversion signal is supplied to each pixel.

Another embodiment of the present invention is a method for driving a liquid crystal display device. The liquid crystal display device includes a signal generation circuit which outputs a polarity inversion signal that is generated in accordance with a count value obtained by counting cycles of a vertical synchronization signal up to m (m is greater than or equal to 2) or more cycles. In the method, the polarity inversion signal is switched between an H level and an L level every m frame periods and a video signal whose polarity is switched in accordance with the polarity inversion signal is supplied to each pixel.

In the method for driving a liquid crystal display device of one embodiment of the present invention, a blank period in which a potential of a video signal is set to a common potential is preferably provided every m frame periods before the polarity of the video signals is switched.

According to one embodiment of the present invention, the frequency of performing inversion driving when video signals are written into each pixel can be reduced. Therefore, the amount of change in video signal potential attributed to the inversion driving can be reduced, which leads to a reduction in power consumption.

### BRIEF DESCRIPTION OF THE DRAWINGS

FIGS. 1A and 1B are a block diagram and a timing chart for describing a liquid crystal display device.

FIG. 2 is a timing chart for describing a liquid crystal display device.

FIGS. 3A to 3C are a block diagram and schematic views for describing a liquid crystal display device.

FIG. 4 is a schematic view for describing a liquid crystal display device.

FIG. 5 is a timing chart for describing a liquid crystal display device.

FIG. 6 is a timing chart for describing a liquid crystal display device.

FIGS. 7A and 7B are schematic views for describing a liquid crystal display device.

FIGS. 8A to 8C are schematic views for describing a liquid crystal display device.

FIGS. 9A and 9B are schematic views for describing a liquid crystal display device.

FIGS. 10A1, 10A2, and 10B are top views and a cross-sectional view illustrating liquid crystal display devices.

FIG. 11 is a cross-sectional view for describing a liquid crystal element.

FIGS. 12A and 12B are cross-sectional views for describing liquid crystal elements.

FIGS. 13A and 13B are cross-sectional views for describing liquid crystal elements.

FIGS. 14A to 14C each illustrate an electronic appliance.

FIGS. 15A to 15C each illustrate an electronic appliance

### DETAILED DESCRIPTION OF THE INVENTION

Hereinafter, embodiments of the present invention will be described in detail with reference to the accompanying drawings. However, the present invention is not limited to the description below, and it is easily understood by those skilled in the art that modes and details disclosed herein can be modified in various ways. Therefore, the present invention is not construed as being limited to description of the embodiments.

Note that the size, the thickness of a layer, signal waveform, and a region in structures illustrated in the drawings and the like in the embodiments are exaggerated for simplicity in some cases. Therefore, embodiments of the present invention are not limited to such scales.

Note that in this specification, ordinal numbers such as “first”, “second”, “third”, and “N-th” (N is a natural number) are used in order to avoid confusion between components and thus do not limit the number of the components.

### Embodiment 1

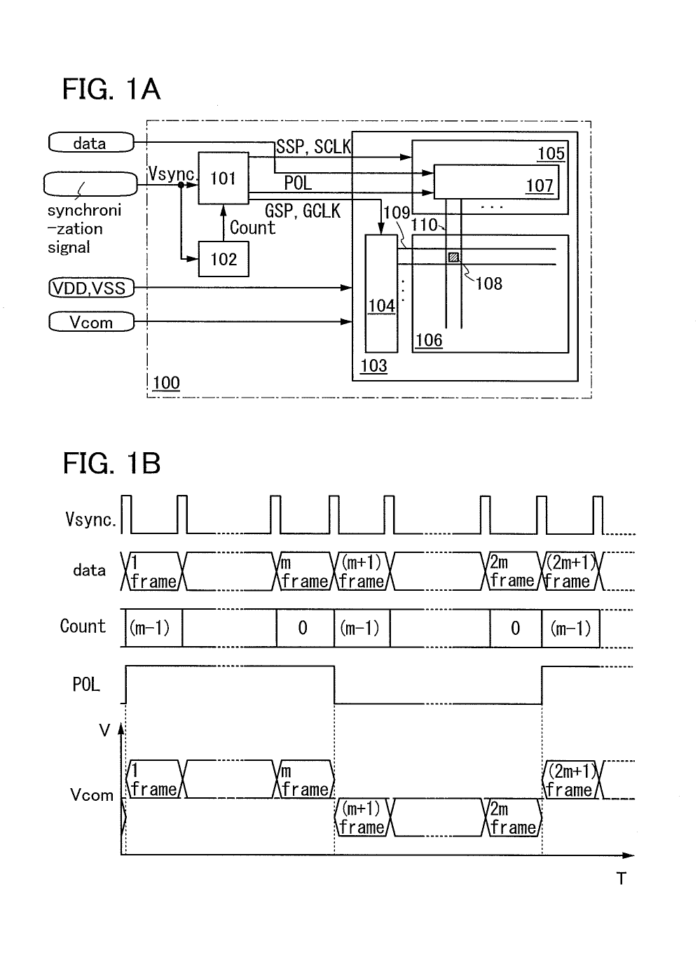

In this embodiment, one mode of a liquid crystal display device and one mode of a method for driving the liquid crystal display device are described with reference to FIGS. 1A and 1B, FIG. 2, FIGS. 3A to 3C, FIG. 4, FIG. 5, FIG. 6, FIGS. 7A and 7B, FIGS. 8A to 8C, and FIGS. 9A and 9B.

FIG. 1A is a block diagram illustrating one embodiment of a liquid crystal display device. A liquid crystal display device 100 in FIG. 1A includes a display control signal generation circuit 101, a counter circuit 102, and a display panel 103.

The display panel 103 includes a gate line driver circuit 104, a source line driver circuit 105, and a pixel portion 106. The source line driver circuit 105 includes a digital/analog conversion circuit 107. The pixel portion 106 includes a plurality of pixels 108. In the pixel 108, a scan signal supplied to a gate line 109 controls writing of a video signal supplied to a source line 110.

Power supply voltages based on a high power supply potential VDD and a low power supply potential VSS and a common potential Vcom are supplied to the display panel 103.

The display control signal generation circuit 101 outputs signals for operating the gate line driver circuit 104 and the source line driver circuit 105 on the basis of a synchronization signal externally input.

Examples of a synchronization signal include a horizontal synchronization signal (Hsync.), a vertical synchronization signal (Vsync.), and a reference clock signal (CLK).

Examples of a signal for operating the gate line driver circuit 104 include a gate line side start pulse GSP and a gate line side clock signal GCLK. Note that the gate line side clock signal GCLK may be a plurality of gate line side clock signals with shifted phases.

Examples of a signal for operating the source line driver circuit 105 include a source line side start pulse SSP and a source line side clock signal SCLK. Note that the source line side clock signal SCLK may be a plurality of source line side clock signals with shifted phases.

A data signal “data” externally input and a polarity inversion signal POL input from the display control signal generation circuit 101 are supplied to the digital/analog conversion circuit 107 included in the source line driver circuit 105. The digital/analog conversion circuit 107 converts the data signal “data” into an analog video signal in accordance with the polarity inversion signal POL. The conversion of a data signal into an analog video signal may be performed with a circuit in which a ladder resistor circuit and a switch are combined, and gamma correction or the like may be performed concurrently therewith.

Note that the digital/analog conversion circuit 107 included in the source line driver circuit 105 may be any other kind of circuit as long as the digital/analog conversion circuit 107 can switch the polarity of a video signal output to a pixel in accordance with the polarity inversion signal POL input. For example, it is possible to use an inversion amplifier which switches the polarity of a video signal output to a pixel in accordance with the polarity inversion signal POL.

The data signal “data” externally input is digital data. In the case of being analog data, the data signal “data” is converted into digital data.

The polarity inversion signal POL is a signal for switching between a high potential (positive polarity) and a low potential (negative polarity) with respect to the common potential in converting the data signal “data” into an analog video signal (also referred to as Vdata).

A video signal is a potential based on a data signal “data”. A video signal is a potential that is applied to one electrode of a display element, such as a liquid crystal element, through a source line. The application of a video signal to a display element is also referred to as writing of a video signal to a pixel. When the absolute value of a difference between the potential of a video signal and the common potential is the same as that of a difference between the potential of another video signal and the common potential, the data signal “data” input to the display device is also the same as the other data signal “data” input to the display device. Note that a video signal with a positive polarity is applied to the display element when the potential of the video signal is higher than the common potential. On the other hand, a video signal with a negative polarity is applied to the display element when the potential of the video signal is lower than the common potential.

Note that the response speed of a liquid crystal element can be increased by changing the potential of a video signal written into a pixel to a corrected potential. For example, when the potential of a video signal is corrected to a higher potential, the response time of a liquid crystal element can be shortened. A driving method in which such a correction signal is applied is referred to as overdriving.

The counter circuit 102 outputs a count value (Count) obtained by counting the cycles of a vertical synchronization signal (Vsync.), which is a synchronization signal, to the display control signal generation circuit 101. The counter circuit 102 resets the count value after counting the cycles of a vertical synchronization signal up to in cycles.

In the display control signal generation circuit 101, switching of a polarity inversion signal POL between an H level and an L level is performed in response to reset of a count value in the counter circuit 102. With this structure, the display control signal generation circuit 101 can perform inversion of the polarity inversion signal POL to be output every m frame periods.

Note that in is greater than or equal to 2, and the maximum value thereof is the driving frequency (frame frequency). For example, the maximum value of m may be 60 when the driving frequency is 60 Hz, 120 when the driving frequency is 120 Hz, or 240 when the driving frequency is 240 Hz. Without being limited thereto, the range of m may be widened depending on the kind of a liquid crystal material that is used.

FIG. 1B is a schematic timing chart of signals which are input to and output from the display control signal generation circuit 101, the counter circuit 102, and the display panel 103.

FIG. 1B schematically shows the waveforms of the vertical synchronization signal (Vsync.), the data signal (data), the count value (Count), and the polarity inversion signal POL. In the timing chart of FIG. 1B, the horizontal axis represents time, and the vertical axis represents the potentials of video signals applied to a display element of a pixel.

In the timing chart of FIG. 1B, data signals are continuously supplied in the first to m-th (m is a natural number greater than or equal to 2) frames in synchronization with the cycles of the H level of the vertical synchronization signal. The cycles of the H level of the vertical synchronization signal are counted backward from “m−1”, and the count value is reset when it becomes “0”. The polarity inversion signal POL is inverted in response to the reset of the count value. Thus, the polarity inversion signal POL can be inverted every m frame periods.

Video signals are inverted to have a positive polarity or a negative polarity with respect to the common potential in accordance with the inversion of the polarity inversion signal POL and written into each pixel. As shown in FIG. 1B, operation can be performed with the same polarity kept for m frame periods in the structure of this embodiment.

In general, in a display device using a liquid crystal element as a display element, inversion driving in which the polarity of a video signal applied to the display element is inverted every frame period, such as gate line inversion driving, source line inversion driving, frame inversion driving, or dot inversion driving, is employed. However, in the case where the potentials of video signals applied to a display element are high and inversion driving is performed, even when a difference between the potential of the video signal applied to the display element and the common potential is almost unchanged, the amount of change in the video signal potential increases and accordingly power consumption increases. The increase in power consumption is particularly problematic when the driving frequency is high.

On the other hand, video signals with the same polarity can be continuously written for m or more frame periods in the example shown in FIG. 1B. Therefore, the problem of an increase in the amount of change in the video signal potential attributed to inversion driving in the case of performing inversion driving every frame period can be relieved, which leads to a reduction in power consumption.

Note that in the structure of this embodiment, inversion driving is performed every m frame periods as shown in FIG. 1B. Therefore, there remains a problem in that the video signal potential is greatly changed between in the m-th frame and in the (m+1)-th frame and between in the 2m-th frame and in the (2 m+1)-th frame.

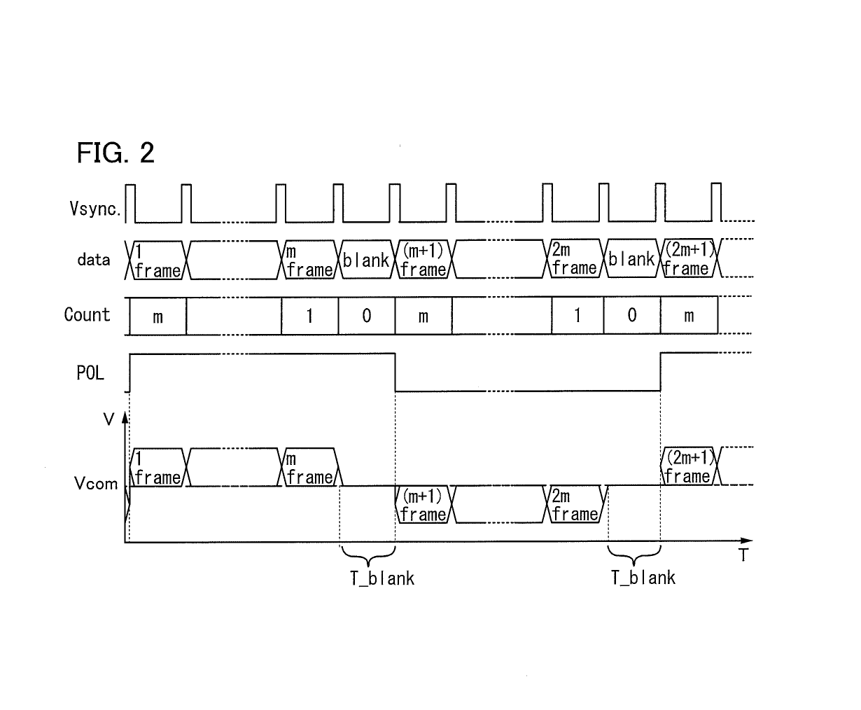

In this case, a blank period (T_blank) in which the potential of a video signal is set equal to the common potential Vcom is preferably provided between the m-th frame and the (m+1)-th frame and between the 2m-th frame and the (2 m+1)-th frame, as shown in FIG. 2.

In the timing chart of FIG. 2, data signals are continuously supplied in the first to m-th (m is a natural number greater than or equal to 2) frames in synchronization with the cycles of the H level of the vertical synchronization signal, and blank data (blank) is written every m frame periods. The cycles of the H level of the vertical synchronization signal are counted backward from “m”, and the count value is reset when it becomes “0”. The polarity inversion signal POL is inverted in response to the reset of the count value. Thus, the polarity inversion signal POL can be inverted every m frame periods.

In the timing chart of FIG. 2, writing can be performed by continuous application of video signals with the same polarity for in or more frame periods while a blank period without writing of a video signal is provided every m frame periods. Therefore, the problem of an increase in the amount of change in the video signal potential attributed to inversion driving in the case of performing inversion driving every frame period can be relieved, which leads to a reduction in power consumption. Moreover, a change in the video signal potential between in the m-th frame and in the (m+1)-th frame and between in the 2m-th frame and in the (2m+1)-th frame can be made small, which leads to a reduction in power consumption.

Next, an effect of this embodiment is described in detail by showing a specific example of a structure of the display panel 103 illustrated in FIG. 1A.

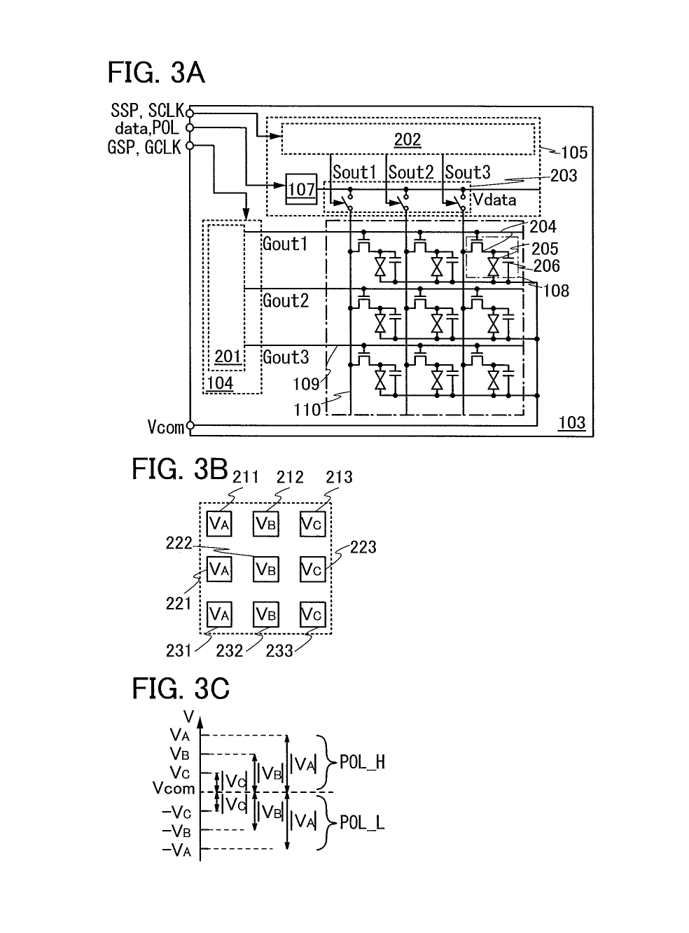

FIG. 3A illustrates a specific configuration of the gate line driver circuit 104, the source line driver circuit 105, and the pixel portion 106 which are included in the display panel 103 illustrated in FIG. 1A.

The gate line driver circuit 104 includes a shift register circuit 201. The source line driver circuit 105 includes a shift register circuit 202, the digital/analog conversion circuit 107, and analog switches 203.

FIG. 3A shows an example in which the pixel portion 106 includes the pixels 108 in a matrix of three rows and three columns. The pixels 108 each include a transistor 204, a capacitor 205, and a liquid crystal element 206. A gate of the transistor is connected to the gate line 109, and one of a source and a drain of the transistor is connected to the source line 110.

In FIG. 3A, a gate line side start pulse GSP and a gate line side clock signal GCLK are input to the shift register circuit 201 included in the gate line driver circuit 104. The shift register circuit 201 sequentially outputs H-level signals as selection signals Gout1 to Gout3 to the gate lines 109 in the first to third rows, thus controlling the conduction states of the transistors 204.

In FIG. 3A, the digital/analog conversion circuit 107 included in the source line driver circuit 105 outputs a video signal Vdata which is generated in accordance with a data signal “data” and a polarity inversion signal POL. When the analog switch 203 is turned on, the video signal Vdata is written into the capacitor 205 and the liquid crystal element 206 of the pixel 108 via the source line 110.

In FIG. 3A, a source line side start pulse SSP and a source line side clock signal SCLK are input to the shift register circuit 202 included in the source line driver circuit 105. The shift register circuit 202 sequentially outputs H-level signals as selection signals Sout1 to Sout3 to the analog switches 203 in the first to third columns, thus controlling the conduction states of the analog switches 203.

FIG. 3B schematically illustrates the pixel portion which includes the pixels in a matrix of three rows and three columns illustrated in FIG. 3A.

In FIG. 3B, “V_{A}” is input as a data signal to be input to a pixel 211 in the first row and the first column, a pixel 221 in the second row and the first column, and a pixel 231 in the third row and the first column. In FIG. 3B, “V_{B}” is input as a data signal to be input to a pixel 212 in the first row and the second column, a pixel 222 in the second row and the second column, and a pixel 232 in the third row and the second column. In FIG. 3B, “V_{C}” is input as a data signal to be input to a pixel 213 in the first row and the third column, a pixel 223 in the second row and the third column, and a pixel 233 in the third row and the third column.

The data signals “V_{A}”, “V_{B}”, and “V_{C}” in FIG. 3B can be represented, respectively, as |V_{A}|, |V_{B}|, and |V_{C}|, which are the magnitudes of differences between the potentials of the corresponding video signals and the common potential. For description, an example of the relation between |V_{A}|, |V_{B}|, and |V_{C}| is represented as |V_{C}|<|V_{B}|<|V_{A}|. In the case where the polarity inversion signal POL is an H-level signal (POL_H), the potentials of the video signals can be represented as “V_{A}”, “V_{B}”, and “V_{C}” as shown in FIG. 3C, and video signals with a positive polarity are written. In the case where the polarity inversion signal POL is an L-level signal (POL_L), the potentials of the video signals can be represented as “−V_{A}”, “−V_{B}”, and “−V_{C}” as shown in FIG. 3C, and video signals with a negative polarity are written. Note that, as shown in FIG. 3C, “V_{A}”, “V_{B}”, and “V_{C}” are equal to “−V_{A}”, “−V_{B}”, and “−V_{C}”, respectively, in the magnitudes of differences between the potentials of the video signals and the common potential.

Next, a specific example of operation in a plurality of frame periods in the driving method of the present invention is described with reference to the schematic view of the pixel portion in FIG. 3B and the schematic view of the positive or negative polarity video signals based on the data signals in FIG. 3C.

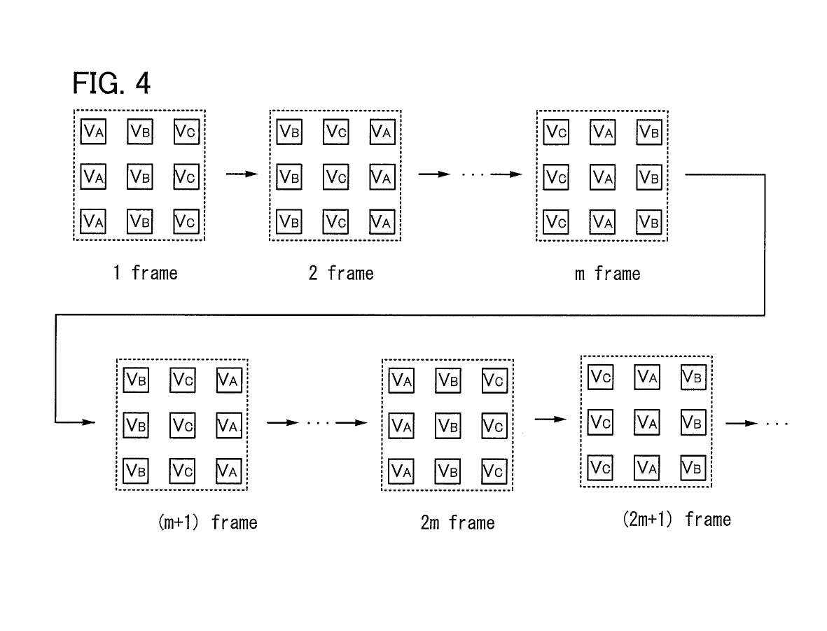

FIG. 4 schematically shows data signals which are input to the pixel portion including pixels in a matrix of three rows and three columns in the first frame, the second frame, the m-th frame, the (m+1)-th frame, the 2m-th frame, and the (2 m+1)-th frame.

In FIG. 4, data signals input to the pixel portion in the first frame are as follows: “V_{A}” is input to the pixels 211, 221, and 231 shown in FIG. 3B; “V_{B}” is input to the pixels 212, 222, and 232 shown in FIG. 3B; and “V_{C}” is input to the pixels 213, 223, and 233 shown in FIG. 3B.

In FIG. 4, data signals input to the pixel portion in the second frame are as follows: “V_{B}” is input to the pixels 211, 221, and 231 shown in FIG. 3B; “V_{C}” is input to the pixels 212, 222, and 232 shown in FIG. 3B; and “V_{A}” is input to the pixels 213, 223, and 233 shown in FIG. 3B.

In FIG. 4, data signals input to the pixel portion in the m-th frame are as follows: “V_{C}” is input to the pixels 211, 221, and 231 shown in FIG. 3B; “V_{A}” is input to the pixels 212, 222, and 232 shown in FIG. 3B; and “V_{B}” is input to the pixels 213, 223, and 233 shown in FIG. 3B.

In FIG. 4, data signals input to the pixel portion in the (m+1)-th frame are as follows: “V_{B}” is input to the pixels 211, 221, and 231 shown in FIG. 3B; “V_{C}” is input to the pixels 212, 222, and 232 shown in FIG. 3B; and “V_{A}” is input to the pixels 213, 223, and 233 shown in FIG. 3B.

In FIG. 4, data signals input to the pixel portion in the 2m-th frame are as follows: “V_{A}” is input to the pixels 211, 221, and 231 shown in FIG. 3B; “V_{B}” is input to the pixels 212, 222, and 232 shown in FIG. 3B; and “V_{C}” is input to the pixels 213, 223, and 233 shown in FIG. 3B.

In FIG. 4, data signals input to the pixel portion in the (2 m+1)-th frame are as follows: “V_{C}” is input to the pixels 211, 221, and 231 shown in FIG. 3B; “V_{A}” is input to the pixels 212, 222, and 232 shown in FIG. 3B; and “V_{B}” is input to the pixels 213, 223, and 233 shown in FIG. 3B.

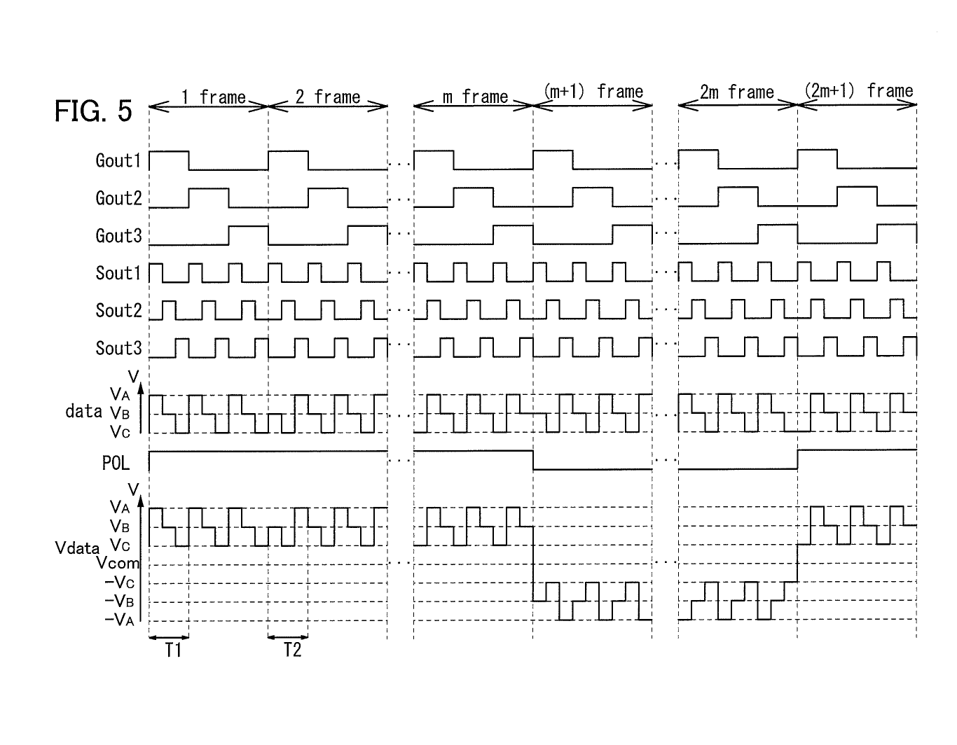

FIG. 5 is a timing chart based on the input of data signals to the pixel portion shown in FIG. 4. The timing chart of FIG. 5 shows the selection signals Gout1 to Gout3, the selection signals Sout1 to Sout3, the data signals “data”, the polarity inversion signal POL, and the video signals Vdata in the first frame, the second frame, the m-th frame, the (m+1)-th frame, the 2m-th frame, and the (2 m+1)-th frame. Note that in the timing chart of FIG. 5, dot sequential driving is employed; however, line sequential driving may also be employed.

In the timing chart of FIG. 5, inversion of the polarity inversion signal POL can be performed every m frame periods, as described using FIG. 1A. Thus, operation can be performed in this embodiment with the polarity of the video signals Vdata kept the same for m frame periods. Therefore, the problem of an increase in the amount of change in the video signal potential attributed to inversion driving in the case of performing inversion driving every frame period can be relieved, which leads to a reduction in power consumption.

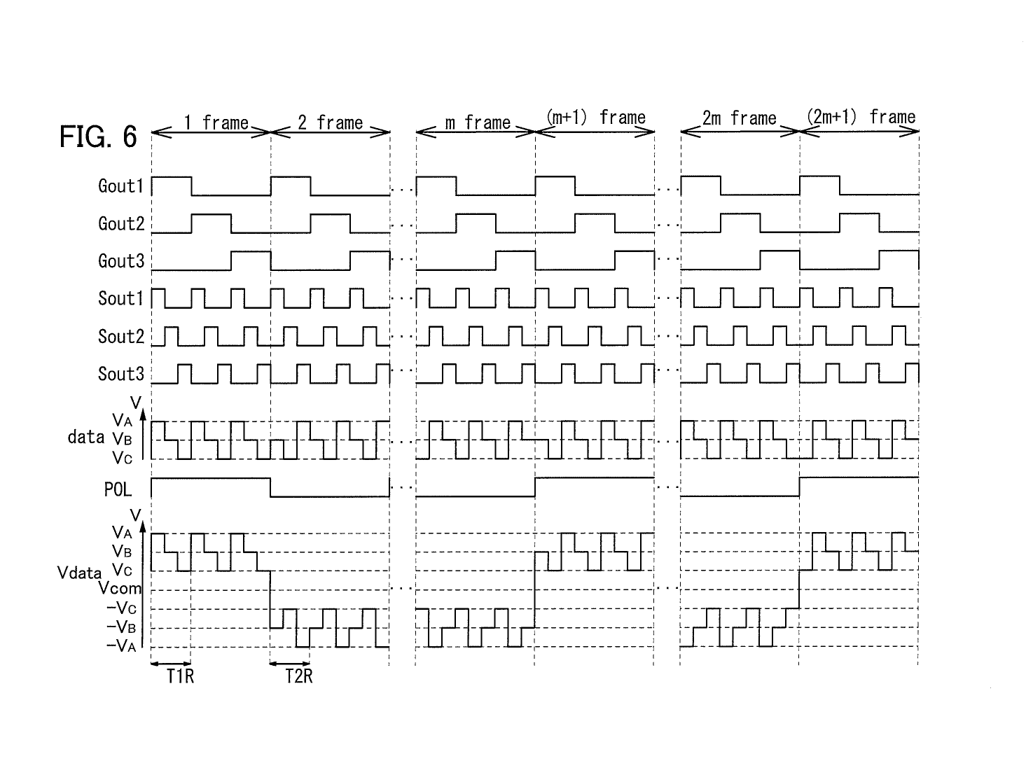

FIG. 6 is a timing chart which shows, for comparison with FIG. 5, frame inversion driving in which the polarity inversion signal POL is inverted every frame period. Note that the data signals “data” input in each frame period in FIG. 6 are similar to those in the timing chart of FIG. 5.

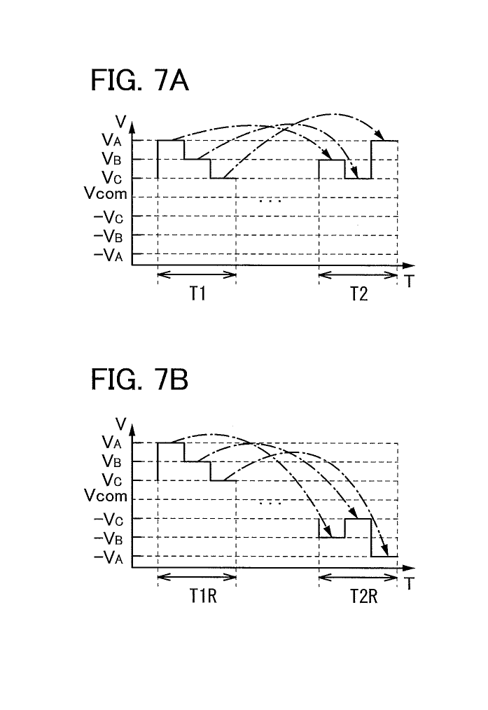

Next, FIGS. 7A and 7B show changes in the video signal potentials in the first row of the pixel portion, which are extracted from the timing charts of FIG. 5 and FIG. 6.

FIG. 7A schematically shows a change in the video signal potentials between in the period T1 and in the period T2, which is extracted from FIG. 5. FIG. 7B schematically shows a change in the video signal potentials between in the period T1R and in the period T2R, which is extracted from FIG. 6.

The potential of the video signal in each column in the first row in the first frame is shown in the period T1 in FIG. 7A. The potential of the video signal in each column in the first row in the second frame is shown in the period T2 in FIG. 7A. The potential of the video signal in each column in the first row in the first frame is shown in the period T1R in FIG. 7B. The potential of the video signal in each column in the first row in the second frame is shown in the period T2R in FIG. 7B. Note that FIGS. 7A and 7B focus on the potentials of the video signals in the same column, and show the changes in those potentials between in the period T1 and in the period T2 and between in the period T1R and in the period T2R with arrows.

In FIG. 7A, the differences in video signal potential between in the first frame and in the second frame in one row are |V_{A}−V_{B}| in the first column, |V_{B}−V_{C}| in the second column, and |V_{C}−V_{A}| in the third column. In FIG. 7B, the differences in video signal potential between in the first frame and in the second frame in one row are |V_{A}+V_{B}| in the first column, |V_{B}+V_{C}| in the second column, and |V_{C}+V_{A}| in the third column.

When FIG. 7A and FIG. 7B are compared with a focus on the difference in video signal potential in the same column, a change in potential is larger in the case of the frame inversion driving in FIG. 7B in which the polarity inversion signal POL is inverted every frame period. In the case of FIG. 7A in which the inversion of the polarity inversion signal POL is performed every m frame periods, the amount of change in the video signal potential in the same column is small. Accordingly, in the case of FIG. 7A, it is possible to reduce power consumed for charge and discharge of the potential of a video signal which is written into a pixel.

Therefore, power consumption can be reduced in the display device of this embodiment.

Although FIGS. 1A and 1B, FIG. 2, FIGS. 3A to 3C, FIG. 4, and FIG. 5 show examples of a structure for performing frame inversion driving, another structure may be employed. A specific example of another structure is described with reference to the schematic view of the pixel portion in FIG. 3B and the schematic view of the positive or negative polarity video signals based on the data signals in FIG. 3C.

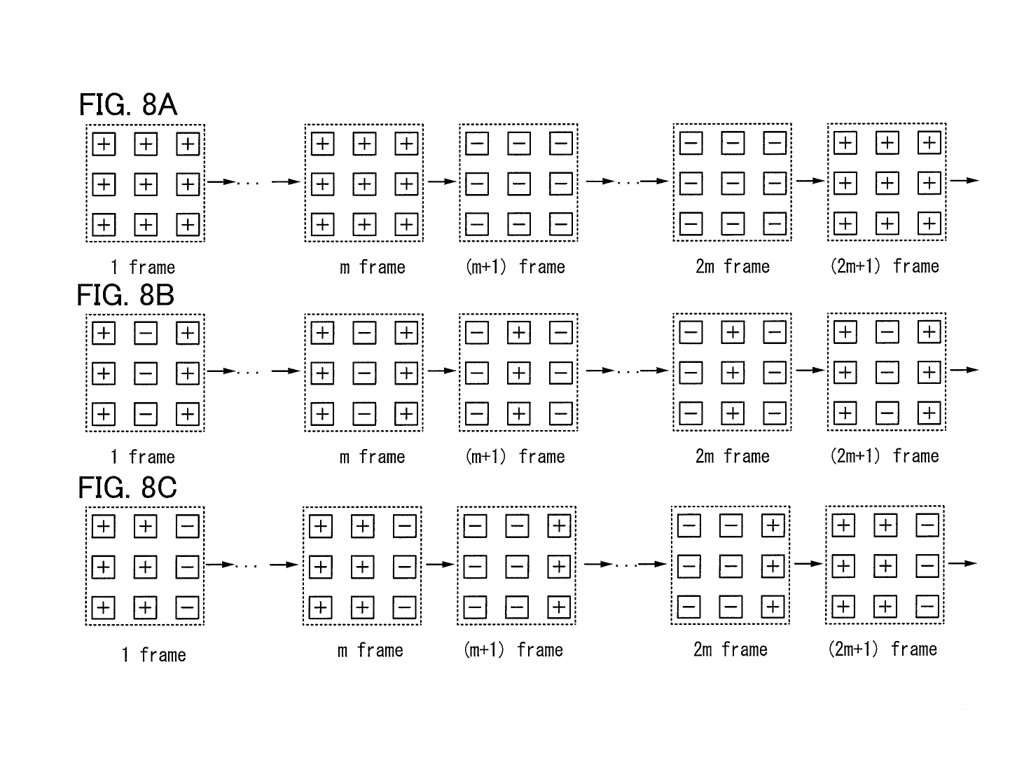

Note that the frame inversion driving described using FIGS. 1A and 1B, FIG. 2, FIGS. 3A to 3C, FIG. 4, and FIG. 5 can be schematically shown by FIG. 8A, in which “+” represents a pixel to which a video signal with a positive polarity is supplied and “−” represents a pixel to which a video signal with a negative polarity is supplied. In the frame inversion driving in FIG. 8A, inversion is performed so that video signals for all the pixels have the same polarity, in accordance with the inversion of the polarity inversion signal POL supplied to the source line driver circuit which is performed every m frame periods.

In FIG. 8B, as another structure, inversion may be performed so that video signals have either a positive polarity or a negative polarity column by column, in accordance with the inversion of the polarity inversion signal POL supplied to the source line driver circuit which is performed every m frame periods. In other words, inversion driving may be performed every m frame periods so that video signals for pixels connected to the same source line have either a positive polarity or a negative polarity.

In FIG. 8C, as another structure, a pixel portion may be divided as appropriate into columns, and inversion driving may be performed so that video signals have a combination of positive and negative polarities, in accordance with the inversion of the polarity inversion signal POL supplied to the source line driver circuit which is performed every m frame periods. In other words, inversion driving may be performed every m frame periods in the pixels arranged in a matrix so that video signals with a positive polarity are supplied to a first area and video signals with a negative polarity are supplied to a second area. Note that the first area and the second area here are given columns in the pixel portion.

In the structures shown in FIGS. 8A to 8C, the video signals supplied to each pixel have the same polarity for m frame periods, and fluctuations in the potential of a source line for writing video signals into the pixels can be reduced. Thus, it is possible to reduce fluctuations in the potential in a pixel and fluctuations in the potential of a source line, thereby enhancing the effect of reducing power consumption.

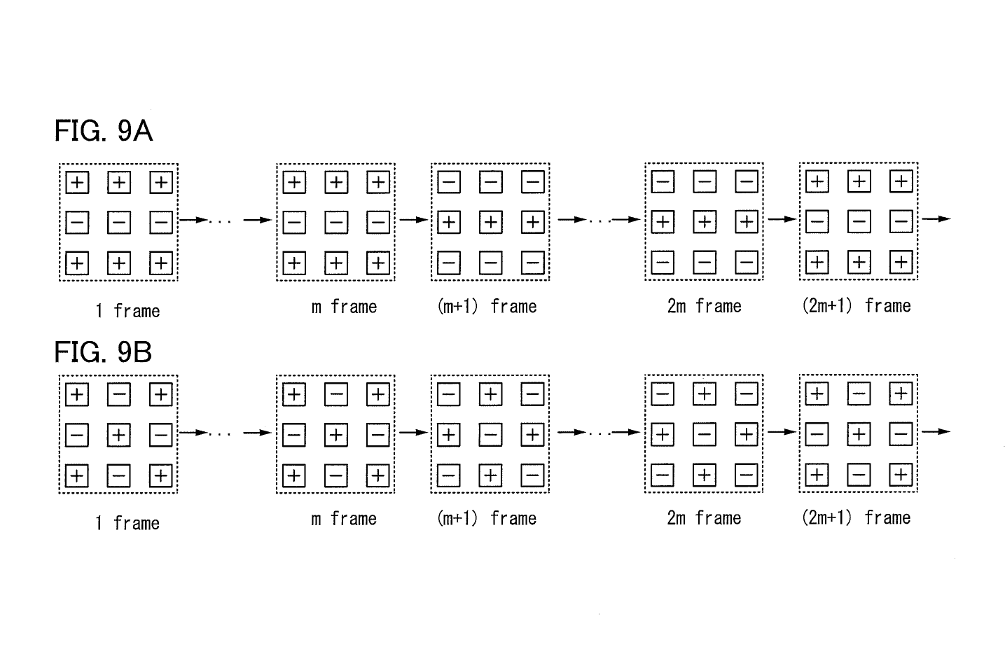

In FIG. 9A, as another structure, inversion may be performed so that video signals have either a positive polarity or a negative polarity row by row, in accordance with the inversion of the polarity inversion signal POL supplied to the source line driver circuit which is performed every m frame periods. In other words, inversion driving may be performed every m frame periods so that video signals for pixels connected to the same gate line have either a positive polarity or a negative polarity.

In FIG. 9B, as another structure, in the adjacent pixels in the vertical and horizontal directions, inversion driving may be performed so that video signals have a combination of positive and negative polarities, in accordance with the inversion of the polarity inversion signal POL supplied to the source line driver circuit which is performed every m frame periods. In other words, inversion driving may be performed every m frame periods in the pixels arranged in a matrix so that a video signal with a positive polarity and a video signal with a negative polarity are supplied to the adjacent pixels in the vertical and horizontal directions.

By performing driving in which video signals have a combination of positive and negative polarities as described using FIGS. 8A to 8C and FIGS. 9A and 9B, flickers in viewing the liquid crystal display device or the like are reduced, so that display quality can be improved.

According to the structure of this embodiment, which is described above, video signals with the same polarity can be written for m frame periods. Thus, a reduction in power consumption can be achieved.

### Embodiment 2

In this embodiment, an external view, a cross section, and the like of the display device are illustrated and a structure thereof is described. In this embodiment, an example in which a liquid crystal element is used as the display element is given.

Note that the term “liquid crystal display device” includes any of the following modules in its category: a module provided with a connector, for example, a flexible printed circuit (FPC), a tape automated bonding (TAB) tape, or a tape carrier package (TCP); a module provided with a printed wiring board at the end of a TCP; and a module where an integrated circuit (IC) is directly mounted on a display element by a chip on glass (COG) method.

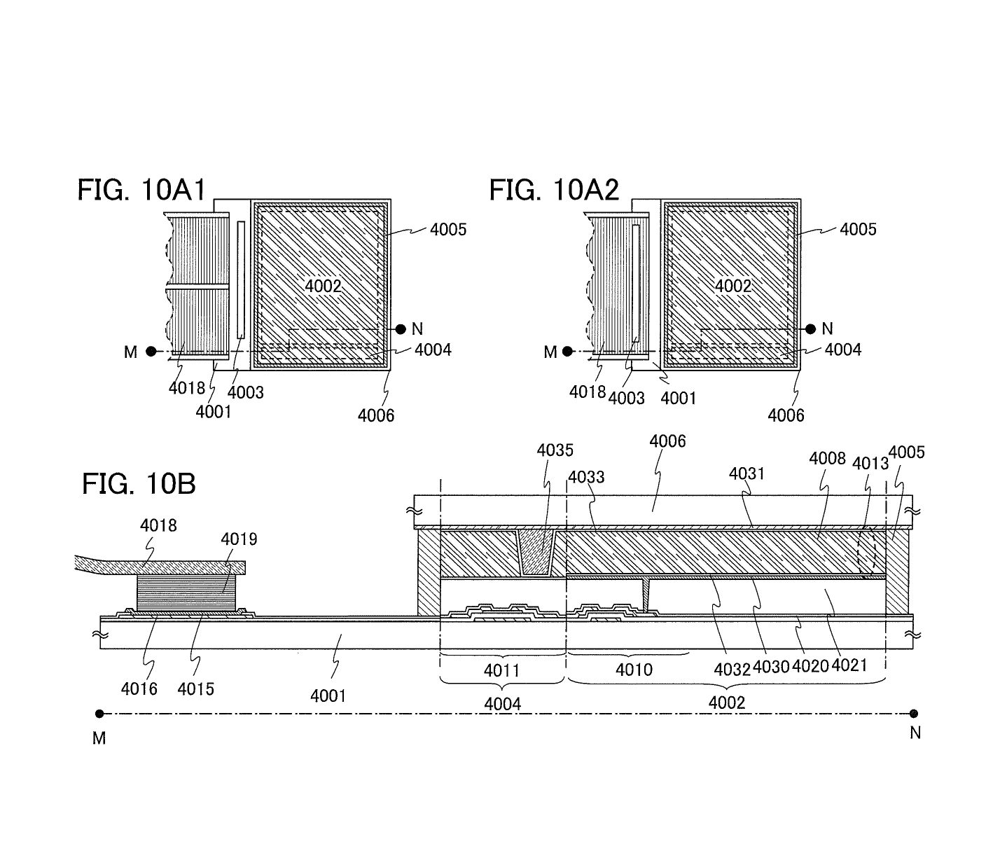

An external view and a cross section of a liquid crystal display device are described with reference to FIGS. 10A1, 10A2, and 10B. FIGS. 10A1 and 10A2 are plan views of a panel in which transistors 4010 and 4011 and a liquid crystal element 4013 are sealed between a first substrate 4001 and a second substrate 4006 with a sealant 4005. FIG. 10B is a cross-sectional view taken along line M-N of FIGS. 10A1 and 10A2.

The sealant 4005 is provided so as to surround a pixel portion 4002 and a gate line driver circuit 4004 which are provided over the first substrate 4001. The second substrate 4006 is provided over the pixel portion 4002 and the gate line driver circuit 4004. Therefore, the pixel portion 4002 and the gate line driver circuit 4004 are sealed together with a liquid crystal layer 4008, by the first substrate 4001, the sealant 4005, and the second substrate 4006. A source line driver circuit 4003 that is formed using a single crystal semiconductor film or a polycrystalline semiconductor film over a substrate separately prepared is mounted in a region that is different from the region surrounded by the sealant 4005 over the first substrate 4001.

Note that there is no particular limitation on the connection method of a driver circuit which is separately formed, and a COG method, a wire bonding method, a TAB method, or the like can be used. FIG. 10A1 illustrates an example of mounting the source line driver circuit 4003 by a COG method, and FIG. 10A2 illustrates an example of mounting the source line driver circuit 4003 by a TAB method.

The pixel portion 4002 and the gate line driver circuit 4004 provided over the first substrate 4001 include a plurality of transistors. FIG. 10B illustrates the transistor 4010 included in the pixel portion 4002 and the transistor 4011 included in the gate line driver circuit 4004. Over the transistors 4010 and 4011, insulating layers 4020 and 4021 are provided.

In each of the transistors 4010 and 4011, a semiconductor thin film of silicon, germanium, or the like in an amorphous, microcrystalline, polycrystalline, or single crystal state can be used as a semiconductor layer. Alternatively, in each of the transistors 4010 and 4011, an oxide semiconductor can be used for a semiconductor layer. In this embodiment, the transistors 4010 and 4011 are n-channel transistors. By using an oxide semiconductor for the semiconductor layer, the transistor used as a switching element of a pixel can have extremely low off-state current. In this case, a fluctuation in the potential of a video signal once written into a pixel is small; thus, display quality can be improved.

A pixel electrode layer 4030 included in the liquid crystal element 4013 is connected to the transistor 4010. The second substrate 4006 is provided with a counter electrode layer 4031 of the liquid crystal element 4013. A portion where the pixel electrode layer 4030, the counter electrode layer 4031, and the liquid crystal layer 4008 overlap with one another corresponds to the liquid crystal element 4013. Note that the pixel electrode layer 4030 and the counter electrode layer 4031 are provided with an insulating layer 4032 and an insulating layer 4033, respectively, which each function as an alignment film, and the liquid crystal layer 4008 is sandwiched between the pixel electrode layer 4030 and the counter electrode layer 4031 with the insulating layers 4032 and 4033 therebetween.

Note that a light-transmitting substrate can be used as the first substrate 4001 and the second substrate 4006; glass, ceramics, or plastics can be used. As plastic, a fiberglass-reinforced plastics (FRP) plate, a polyvinyl fluoride (PVF) film, a polyester film, or an acrylic resin film can be used.

A structure body 4035 is a columnar spacer obtained by selectively etching an insulating film and is provided to control the distance (cell gap) between the pixel electrode layer 4030 and the counter electrode layer 4031. Alternatively, a spherical spacer may be used. In addition, the counter electrode layer 4031 is connected to a common potential line formed over the same substrate as the transistor 4010. With use of the common contact portion, the counter electrode layer 4031 and the common potential line can be connected to each other by conductive particles arranged between a pair of substrates. Note that the conductive particles can be included in the sealant 4005.

Note that a structure of an electrode of a liquid crystal element can be changed as appropriate depending on the display mode of the liquid crystal element.

This embodiment shows the example of the liquid crystal display device in which a polarizing plate is provided on the outer side of the substrate (on the viewer side) and a coloring layer and an electrode layer used for a display element are provided in this order on the inner side of the substrate; alternatively, a polarizing plate may be provided on the inner side of the substrate. The stacked structure of the polarizing plate and the coloring layer is not limited to that in this embodiment and may be set as appropriate depending on materials of the polarizing plate and the coloring layer or conditions of manufacturing process. Further, a light-blocking film serving as a black matrix may be provided in a portion other than the display portion.

The transistors 4010 and 4011 each include a gate insulating layer, a gate electrode layer, and a wiring layer (e.g., a source wiring layer or a capacitor wiring layer), in addition to the semiconductor layer.

The insulating layer 4020 is formed over the transistors 4010 and 4011. As the insulating layer 4020, a silicon nitride film is formed by an RF sputtering method, for example.

The insulating layer 4021 is formed as the planarizing insulating film. As the insulating layer 4021, an organic material having heat resistance such as polyimide, acrylic, a benzocyclobutene-based resin, polyamide, or epoxy can be used. Other than such organic materials, it is also possible to use a low-dielectric constant material (a low-k material), a siloxane-based resin, PSG (phosphosilicate glass), BPSG (borophosphosilicate glass), or the like. Note that the insulating layer 4021 may be formed by stacking a plurality of insulating films formed of these materials.

The pixel electrode layer 4030 and the counter electrode layer 4031 can be formed using a light-transmitting conductive material such as indium oxide containing tungsten oxide, indium zinc oxide containing tungsten oxide, indium oxide containing titanium oxide, indium tin oxide containing titanium oxide, indium tin oxide, indium zinc oxide, or indium tin oxide to which silicon oxide is added.

Further, a variety of signals and potentials are supplied to the source line driver circuit 4003 which is rimmed separately, the gate line driver circuit 4004, or the pixel portion 4002 from an FPC 4018.

A connection terminal electrode 4015 is formed with the same conductive film as that of the pixel electrode layer 4030 included in the liquid crystal element 4013, and a terminal electrode 4016 is formed with the same conductive film as that of the source and drain electrode layers of the transistors 4010 and 4011.

The connection terminal electrode 4015 is electrically connected to a terminal included in the FPC 4018 via an anisotropic conductive film 4019.

FIGS. 10A1, 10A2, and 10B illustrate an example in which the source line driver circuit 4003 is formed separately and mounted on the first substrate 4001; however, this embodiment is not limited to this structure. The gate line driver circuit may be separately formed and then mounted, or only part of the source line driver circuit or part of the gate line driver circuit may be separately formed and then mounted.

This embodiment can be implemented in appropriate combination with any of the structures described in the other embodiments.

### Embodiment 3

This embodiment shows the display mode of the liquid crystal element described in Embodiment 2. Although Embodiment 2 shows an example of the cross section of a twisted nematic (TN) mode liquid crystal element, the liquid crystal element can employ another display mode. Electrodes and substrates used for operating liquid crystal in various display modes will be described below with reference to schematic views.

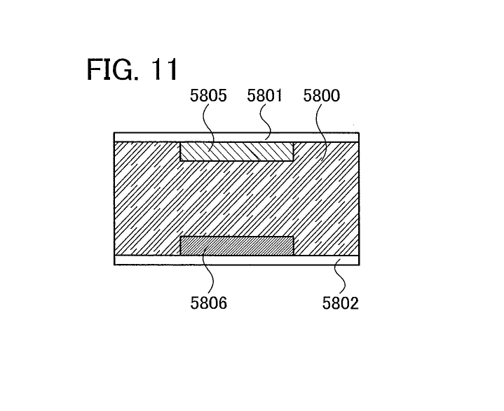

FIG. 11 is a schematic view illustrating a cross section of a TN mode liquid crystal element.

A liquid crystal layer 5800 is sandwiched between a first substrate 5801 and a second substrate 5802 that are placed opposite to each other. A first electrode 5805 is formed on the first substrate 5801. A second electrode 5806 is formed over the second substrate 5802.

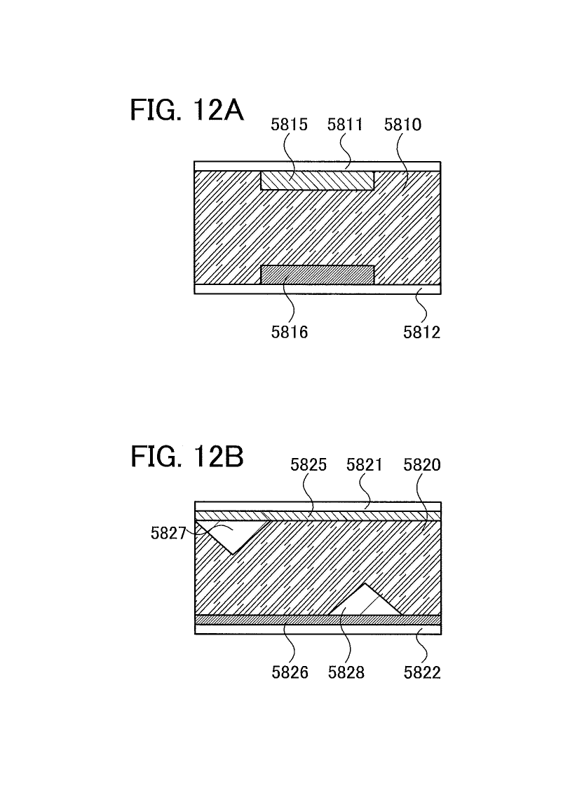

FIG. 12A is a schematic view illustrating a cross section of a vertical alignment (VA) mode liquid crystal element. In the VA mode, liquid crystal molecules are aligned vertically to the substrates when there is no electric field.

A liquid crystal layer 5810 is sandwiched between a first substrate 5811 and a second substrate 5812 that are placed opposite to each other. A first electrode 5815 is formed on the first substrate 5811. A second electrode 5816 is formed over the second substrate 5812.

FIG. 12B is a schematic view illustrating a cross section of a multi-domain vertical alignment (MVA) mode liquid crystal element. In the MVA mode, protrusions are provided so that liquid crystal molecules are aligned in a plurality of directions to compensate the viewing angle dependence.

A liquid crystal layer 5820 is sandwiched between a first substrate 5821 and a second substrate 5822 that are placed opposite to each other. A first electrode 5825 is formed on the first substrate 5821. A second electrode 5826 is formed over the second substrate 5822. A first protrusion 5827 for controlling alignment is formed on the first electrode 5825. A second protrusion 5828 for controlling alignment is formed over the second electrode 5826.

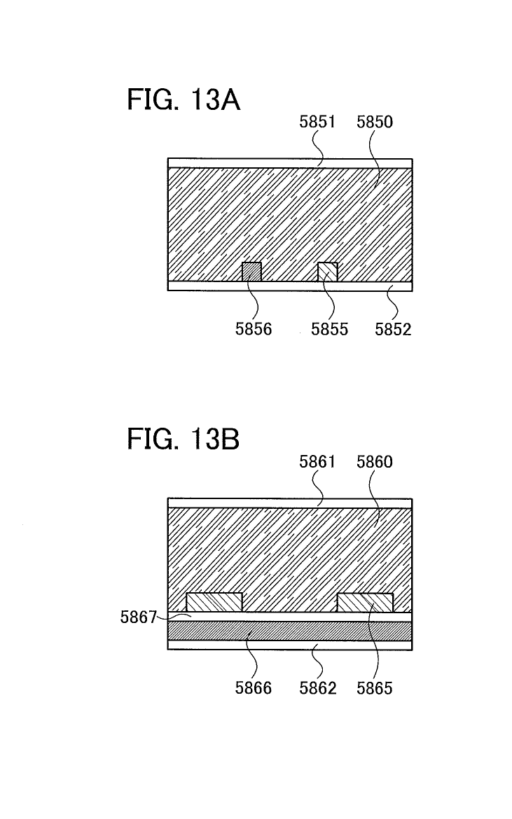

FIG. 13A is a schematic view illustrating a cross section of an in-plane switching (IPS) mode liquid crystal element. In the IPS mode, liquid crystal molecules always rotate in a plane parallel to substrates. The viewing angle dependence is small because of small difference in refractive index of a liquid crystal layer with varying angles for viewing a screen. The IPS mode employs a horizontal electric field mode for which electrodes are provided only on one substrate.

A liquid crystal layer 5850 is sandwiched between a first substrate 5851 and a second substrate 5852 that are placed opposite to each other. A first electrode 5855 and a second electrode 5856 are formed over the second substrate 5852.

In the electrode structure for the IPS mode, liquid crystal exhibiting a blue phase for which an alignment film is unnecessary may be used.

FIG. 13B is a schematic view illustrating a cross section of a fringe field switching (FFS) mode liquid crystal element. In the FFS mode, liquid crystal molecules always rotate in a plane parallel to substrates. The viewing angle dependence is small because of small difference in refractive index of a liquid crystal layer with varying angles for viewing a screen. The FFS mode employs a horizontal electric field mode for which electrodes are provided only on one substrate.

A liquid crystal layer 5860 is sandwiched between a first substrate 5861 and a second substrate 5862 that are placed opposite to each other. A second electrode 5866 is formed over the second substrate 5862. An insulating film 5867 is formed over the second electrode 5866. A first electrode 5865 is formed over the insulating film 5867.

This embodiment can be implemented in appropriate combination with any of the structures described in the other embodiments.

### Embodiment 4

In this embodiment, examples of electronic devices including the liquid crystal display device described in any of the above embodiments are described.

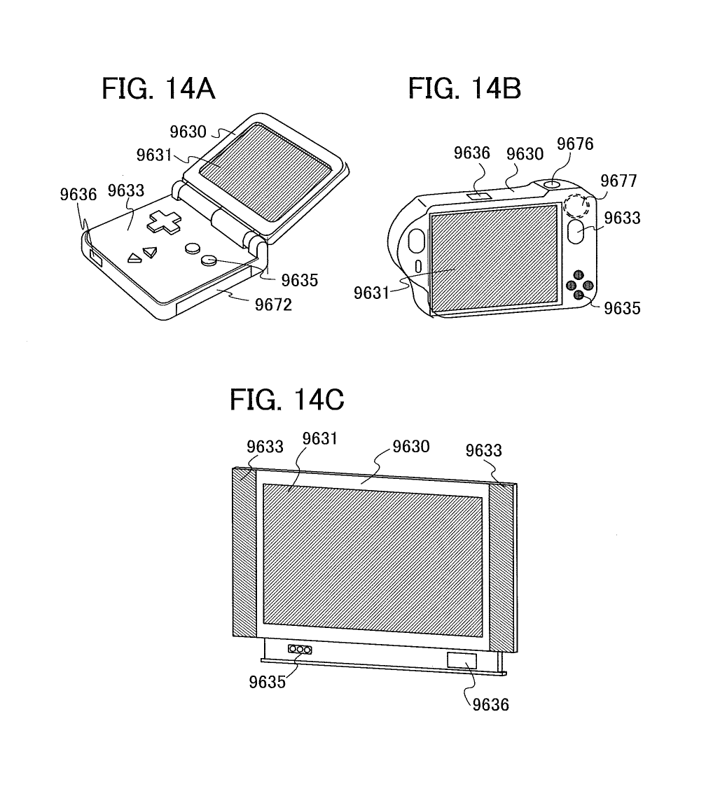

FIG. 14A illustrates a portable game machine which can include a housing 9630, a display portion 9631, speakers 9633, operation keys 9635, a connection terminal 9636, a recording medium reading portion 9672, and the like. The portable game machine illustrated in FIG. 14A can have a function of reading a program or data stored in a recording medium to display it on the display portion, a function of sharing data by wireless communication with another portable game machine, and the like. Note that a function of the portable game machine in FIG. 14A is not limited to the above, and the portable game machine can have a variety of functions.

FIG. 14B illustrates a digital camera which can include the housing 9630, the display portion 9631, the speakers 9633, the operation keys 9635, the connection terminal 9636, a shutter button 9676, an image receiving portion 9677, and the like. The digital camera having a television reception function, which is illustrated in FIG. 14B, can have various functions such as a function of shooting a still image, a function of shooting a moving image, a function of automatically or manually adjusting the shot image, a function of obtaining various kinds of data from an antenna, a function of storing the shot image or the data obtained from the antenna, and a function of displaying the shot image or the data obtained from the antenna on the display portion. Note that the functions of the digital camera having a television reception function, which is illustrated in FIG. 14B, are not limited to those, and the digital camera can have other various functions.

FIG. 14C illustrates a television set which can include the housing 9630, the display portion 9631, the speakers 9633, the operation key 9635, the connection terminal 9636, and the like. The television set in FIG. 14C has a function of converting an electric wave for television into an image signal, a function of converting an image signal into a signal suitable for display, a function of converting the frame frequency of an image signal, and the like. Note that the television set in FIG. 14C can have a variety of functions without limitation to the above.

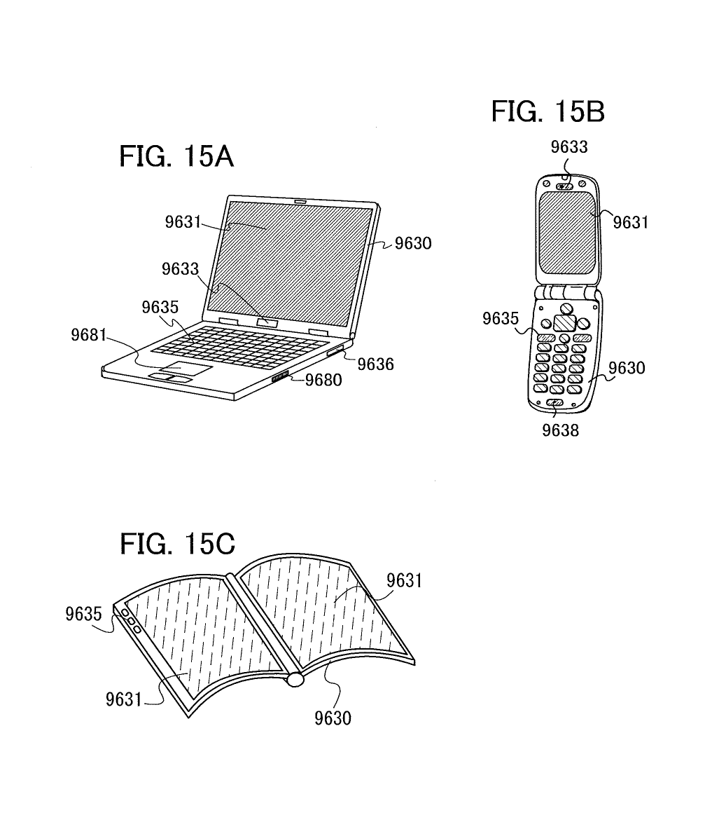

FIG. 15A illustrates a computer which can include the housing 9630, the display portion 9631, the speaker 9633, the operation keys 9635, the connection terminal 9636, a pointing device 9681, an external connecting port 9680, and the like. The computer in FIG. 15A can have a function of displaying various kinds of data (e.g., a still image, a moving image, and a text image) on the display portion, a function of controlling processing by various kinds of software (programs), a communication function such as wireless communication or wired communication, a function of being connected to various computer networks with the communication function, a function of transmitting or receiving a variety of data with the communication function, and the like. Note that the computer in FIG. 15A can have a variety of functions without limitation to the above.

FIG. 15B illustrates a mobile phone which can include the housing 9630, the display portion 9631, the speaker 9633, the operation keys 9635, a microphone 9638, the external connection port 9680, and the like. The mobile phone in FIG. 15B can have a function of displaying various kinds of data (e.g., a still image, a moving image, and a text image) on the display portion; a function of displaying a calendar, a date, the time, or the like on the display portion; a function of operating or editing the data displayed on the display portion; a function of controlling processing by various kinds of software (programs); and the like. Note that the functions of the mobile phone in FIG. 15B are not limited to those described above, and the mobile phone can have various functions.

FIG. 15C illustrates electronic paper (also referred to as an eBook or an e-book reader) which can include the housing 9630, the display portion 9631, the operation keys 9635, and the like. The e-book reader in FIG. 15C can have a function of displaying various kinds of data (e.g., a still image, a moving image, and a text image) on the display portion; a function of displaying a calendar, a date, the time, and the like on the display portion; a function of operating or editing the data displayed on the display portion; a function of controlling processing by various kinds of software (programs); and the like. Note that the e-book reader in FIG. 15C can have a variety of functions without limitation to the above functions.

The electronic device in this embodiment achieves low power consumption by including the liquid crystal display device described in any of the above embodiments.

This embodiment can be implemented in appropriate combination with any of the structures described in the other embodiments.

This application is based on Japanese Patent Application serial no. 2012-157456 filed with Japan Patent Office on Jul. 13, 2012, the entire contents of which are hereby incorporated by reference.

What is claimed is:

1. A liquid crystal display device comprising:
a signal generation circuit configured to output a polarity inversion signal that is generated in accordance with a count value obtained by counting cycles of a vertical synchronization signal; and
a source driver configured to switch a polarity of video signals to be input to a pixel in accordance with the polarity inversion signal,
wherein the polarity of the video signals is kept the same for m (m is greater than or equal to 2) or more frame periods by the polarity inversion signal.

2. The liquid crystal display device according to claim 1, wherein the video signals supplied in accordance with the polarity inversion signal in one frame period have the same polarity in all the pixels.

3. The liquid crystal display device according to claim 1, wherein the video signals supplied in accordance with the polarity inversion signal in one frame period have either a positive polarity or a negative polarity in pixels connected to the same source line.

4. The liquid crystal display device according to claim 1, wherein the video signals supplied in accordance with the polarity inversion signal in one frame period have a positive polarity in a first region of pixels arranged in a matrix and a negative polarity in a second region of the pixels.

5. The liquid crystal display device according to claim 1, wherein a blank period in which a potential of a video signal is set to a common potential is provided every m frame periods before the polarity of the video signals is switched.

6. A liquid crystal display device comprising:
a signal generation circuit configured to output a polarity inversion signal that is generated in accordance with a count value obtained by counting cycles of a vertical synchronization signal; and
a source driver configured to switch a polarity of video signals to be input to a pixel in accordance with the polarity inversion signal,
wherein the cycles of the vertical synchronization signal are counted up to m (m is greater than or equal to 2) or more cycles so that the polarity of the video signals is kept the same for in or more frame periods by the polarity inversion signal.

7. The liquid crystal display device according to claim 6, wherein the video signals supplied in accordance with the polarity inversion signal in one frame period have the same polarity in all the pixels.

8. The liquid crystal display device according to claim 6, wherein the video signals supplied in accordance with the polarity inversion signal in one frame period have either a positive polarity or a negative polarity in pixels connected to the same source line.

9. The liquid crystal display device according to claim 6, wherein the video signals supplied in accordance with the polarity inversion signal in one frame period have a positive polarity in a first region of pixels arranged in a matrix and a negative polarity in a second region of the pixels.

10. The liquid crystal display device according to claim 6, wherein a blank period in which a potential of a video signal is set to a common potential is provided every m frame periods before the polarity of the video signals is switched.

11. A method for driving a liquid crystal display device, the liquid crystal display device comprising a signal generation circuit configured to output a polarity inversion signal that is generated in accordance with a count value obtained by counting cycles of a vertical synchronization signal,
the method comprising the step of:
switching the polarity inversion signal between an H level and an L level every m (m is greater than or equal to 2) frame periods, and
supplying a video signal whose polarity is switched in accordance with the polarity inversion signal to each pixel.

12. The method for driving a liquid crystal display device according to claim 11, wherein the cycles of the vertical synchronization signal are counted up to in (in is greater than or equal to 2) or more cycles.

13. The method for driving a liquid crystal display device according to claim 11, wherein a blank period in which a potential of a video signal is set to a common potential is provided every m frame periods before the polarity of the video signals is switched.
